(19) United States
(12) Patent Application Publication
(10) Pub. No.: US 2011/0125662 A1
(43) Pub. Date: May 26, 2011

(54) EMPLOYEE MEDICAL CARE MANAGEMENT TOOL AND METHOD

(75) Inventors: Jeffrey T. Perry, Chandler, AZ (US); Jon Paul Moorhead, Peoria, AZ (US); Edward W. Schwartz, Phoenix, AZ (US); Richard Kenneth Porter, Cave Creek, AZ (US); Lisa J. Stilwell, Fountain Hills, AZ (US); Julia Lu, Phoenix, AZ (US); Shawn N. White, Peoria, AZ (US)

(73) Assignee: CIGNA CORPORATION, Philadelphia, PA (US)

(21) Appl. No.: 12/626,485

(22) Filed: Nov. 25, 2009

(51) Int. Cl. G06Q 10/00

(52) U.S. Cl. 705/322

(57) ABSTRACT

The invention provides an employee medical care management method including (i) a wellness program management method including storing a purchased subset of the wellness programs; (ii) an employee health analysis method including storing a plurality of employee records, and for each employee record, storing at least one medical variable so that the medical variable is associated with the employee record; (iii) an employee health directive method including associating at least a selected one of the medical wellness programs with the employee record based on the medical variable associated with the employee record, and providing an output with the selected medical wellness program being associated with the employee record.

### BACKGROUND OF THE INVENTION

1). Field of the Invention

This invention relates to an employee medical management tool and method.

2). Discussion of Related Art

Employers often purchase group medical insurance from insurance companies. Employees can then obtain medical services from medical caregivers such as doctors or various specialists.

It has also become common for insurance companies to provide medical wellness programs for employers. An employer may purchase for example, a cardiovascular health program, a smoking cessation program etc. The employer may advertise the medical wellness programs to employees.

An employee may not know which programs apply to him or her. For example, an employee with a high Body Mass Index (BMI) may have need for a nutrition program without realizing the need. Employees often also do not know what benefits are provided by which programs. Other obligations may also prevent the employee from enrolling into an appropriate program. For these and other reasons, enrollment into purchased medical wellness programs is usually not very good. As a result, the employer may not benefit from improved health of its employees.

### SUMMARY OF THE INVENTION

The invention provides an employee medical care management method including (i) a wellness program management method including storing a purchased subset of the wellness programs; (ii) an employee health analysis method including storing a plurality of employee records, and for each employee record, storing at least one medical variable so that the medical variable is associated with the employee record; (iii) an employee health directive method including associating at least a selected one of the medical wellness programs with the employee record based on the medical variable associated with the employee record, and providing an output with the selected medical wellness program being associated with the employee record.

The wellness program management method may include storing a plurality of employee records, and storing a plurality of wellness programs, wherein a respective purchased subset of the wellness programs may be associated with a respective one of the employer records.

The wellness program management method may also provide, in the employee health directive method, the medical wellness program for association with the employee record may be selected only from the purchased subset of medical wellness programs of the employer record associated with the employee record.

The wellness program management method may also provide, in the employee health directive method, a selection of medical wellness programs may be associated with the employee record, the selection being a plurality of medical wellness programs selected from the subset of purchased medical wellness programs.

The employee health analysis method may include importing the medical variable in association with the respective employee record.

The employee health analysis method may further include displaying an interface for entering the medical variable, and receiving an input of the medical variable.

The medical variable may be at least one of BMI, percent body fat, systolic blood pressure, diastolic blood pressure, total cholesterol, HDL cholesterol, LDL cholesterol, triglycerides, cholesterol ratio, tobacco use, diabetes, asthma, hypertension and hyperlipidemia.

The employee medical care management method may include displaying the employee record, medical variable and selected wellness program together.

The employee medical care management method may include storing enrollment data associated with the wellness program, and displaying the enrollment data to indicate enrollment/non-enrollment into the selected wellness program.

The employee medical care management method may include importing the enrollment data.

The invention further provides an employee medical care management method including (i) a wellness program management method including storing a plurality of employer records, storing a plurality of wellness programs, and associating a respective purchased subset of the wellness programs with a respective one of the employer records; (ii) an employee health analysis method including storing a plurality of employee records, and associating a respective subset of the employee records with a respective one of the employer records, and for each employee record, storing at least one medical variable so that the medical variable is associated with the employee record; and (iii) an employee health directive method including associating at least a selected one of the medical wellness programs with the employee record based on the medical variable associated with the employee record, the medical wellness program for association with the employee record being selected only from the purchased subset of medical wellness programs of the employer record associated with the employee record, and providing an output with the selected medical wellness program being associated with the employee record.

The invention further provides an employee medical care management tool including (i) at least one processor; (ii) at least one storage device connected to the processor; (iii) a wellness program management system stored on the storage device and executable by the processor to carry out the method including storing a purchased subset of the wellness programs; (iv) an employee health analysis system stored on the storage device and executable by the processor to carry out the method including storing a plurality of employee records, and for each employee record, storing at least one medical variable so that the medical variable is associated with the employer record; (v) an employee health directive system stored on the storage device and executable by the processor to carry out the method including associating at least a selected one of the medical wellness programs with the employee record based on the medical variable associated with the employee record, and providing an output with the selected medical wellness program being associated with the employee record.

The wellness program management system may carry out the method including storing a plurality of employer records, and storing a plurality of wellness programs, wherein a respective purchased subset of the wellness programs may be associated with a respective one of the employer records.

The employee medical care management tool may provide, in the employee health directive system, the medical wellness program for association with the employee record may be selected only from the purchased subset of medical wellness programs of the employer record associated with the employee record.

The employee medical care management tool may further provide, in the employee health directive system, a selection of medical wellness programs may be associated with the employee record, the selection being a plurality of medical wellness programs selected from the subset of purchased medical wellness programs.

The employee health analysis system may carry out the method including importing the medical variable in association with the respective employee record.

The employee health analysis system may carry out the method including displaying an interface for entering the medical variable, and receiving an input of the medical variable.

The medical variable may be at least one of BMI, percent body fat, systolic blood pressure, diastolic blood pressure, total cholesterol, HDL cholesterol, LDL cholesterol, triglycerides, cholesterol ratio, tobacco use, diabetes, asthma, hypertension and hyperlipidemia.

The employee medical care management tool may include a data communication system that may carry out the method including displaying the employee record, medical variable and selected wellness program together.

The data communication system may carry out the method including storing enrollment data associated with the wellness program, and displaying the enrollment data to indicate enrollment/non-enrollment into the selected wellness program.

The data communication system may carry out the method including importing the enrollment data.

The invention further provides an employee medical care management tool including (i) at least one processor; (ii) at least one storage device connected to the processor; (iii) a wellness program management system stored on the storage device and executable by the processor to carry out the method including storing a plurality of employer records, storing a plurality of wellness programs and associating a respective purchased subset of the wellness programs with a respective one of the employer records; (iv) an employee health analysis system stored on the storage device and executable by the processor to carry out the method including storing a plurality of employee records and associating a respective subset of the employee records with a respective one of the employer records, and for each employee record, storing at least one medical variable so that the medical variable is associated with the employee record; and (v) an employee health directive system stored on the storage device and executable by the processor to carry out the method including associating at least a selected one of the medical wellness programs with the employee record based on the medical variable associated with the employee record, the medical wellness program for association with the employee record being selected only from the purchased subset of medical wellness programs of the employer record associated with the employee record, and providing an output with the selected medical wellness program being associated with the employee record.

### BRIEF DESCRIPTION OF THE DRAWINGS

The invention is further described by way of example with reference to the accompanying drawings, wherein:

FIG. 1 is a block diagram of an employee medical care management system according to an embodiment of the invention;

FIG. 2 is a schematic diagram illustrating a relationship between medical wellness programs that are sold by an insurance provider, employer records and employee records;

FIG. 3 is a flow chart illustrating a wellness program management method forming a first part of an employee medical care management method;

FIG. 4 is flow chart illustrating an employee health analysis method forming a second part of the employee medical care management method;

FIG. 5 is a flow chart illustrating an employee health directive method, an enrollment data association method and a display method forming part of the employee medical care management method;

FIG. 6 is a screen shot of a patient level dashboard showing medical variables and medical wellness programs for one employee record at a particular moment in time;

FIG. 7 is a screenshot of the patient level dashboard showing a change in each medical variable over time; and

FIG. 8 is a block diagram of a machine in the form of a computer system that may form part of the invention.

### DETAILED DESCRIPTION OF THE INVENTION

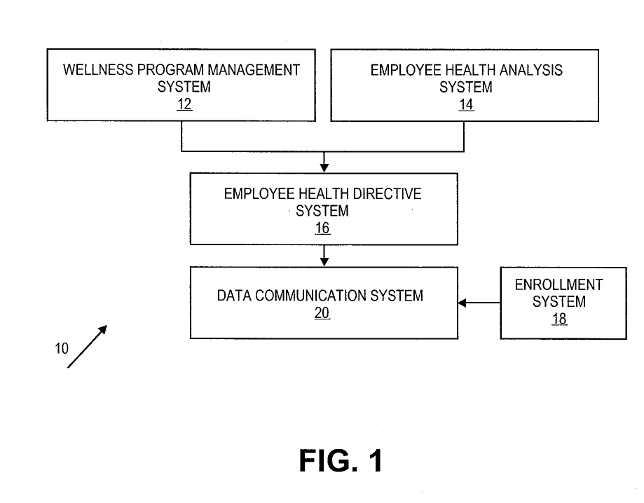

FIG. 1 of the accompanying drawings illustrates an employee medical care management tool 10, according to an embodiment of the invention, including a wellness program management system 12, an employee health analysis system 14, an employee health directive system 16, an enrollment system 18, and a data communications system 20.

The employee health directive system 16 is connected so as to receive data from both the wellness program management system 12 and the employee health analysis system 14. The purpose of the wellness program management system 12 is to manage the purchasing of wellness programs by employers. The purpose of the employee health analysis system 14 is to determine and record medical variables of employees. The employees who have their medical variables analyzed and recorded with the employee health analysis system 14 are employed with respective ones of the employers who purchase the wellness programs utilizing the wellness program management system 12 and the employee health directive system 16 directs or connects a respective ones of the employees analyzed with the employee health analysis system 14 to respective ones of the wellness programs purchased by the employers utilizing the wellness program management system 12.

The enrollment system 18 collects and records data with respect to enrollment of respective employees into respective wellness programs. The data communications system 20 is connected to both the employee health directive system 16 and the enrollment system 18 so as to compare and provide a visual display of the wellness programs appropriate for an employee and information pertaining to enrollment of the employee into respective wellness programs.

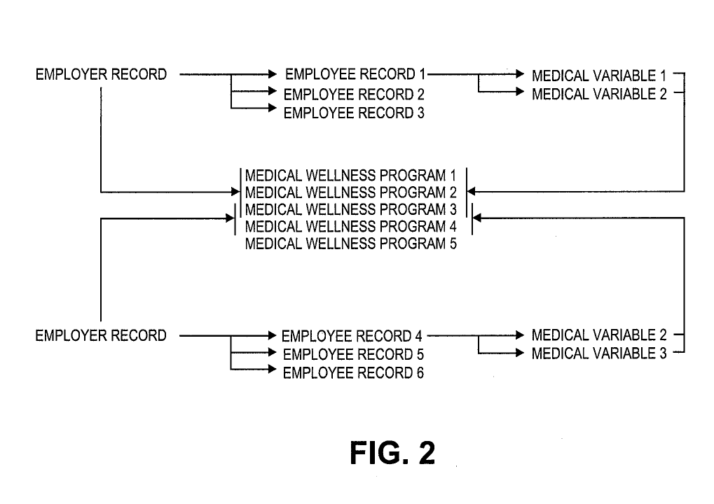

As shown is FIG. 2, the wellness program management system 12 in FIG. 1 stores a plurality of employer records (employer record 1; employer record 2) and a plurality of medical wellness programs (medical wellness program 1 to 5). A respective purchased subset of the wellness programs is associated with each employer record. For example, due to a prior purchase, the medical wellness programs 1 to 3 form a subset of purchased wellness programs that are associated with employer record 1. Similarly, the medical wellness programs 3 and 4 are associated with the employer record 2. As illustrated, the respective purchased subsets may overlap and each purchased subset may include fewer than all the medical wellness programs 1 to 5.

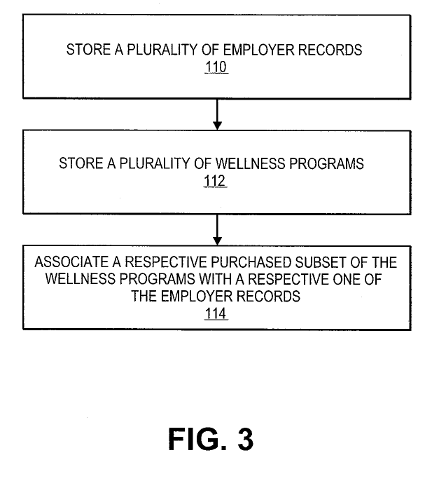

FIG. 3 illustrates a wellness program management method that is carried out by the wellness program management system 12 of FIG. 1. At block 110, a plurality of employer records are stored. At block 112, a plurality of wellness programs are stored. At block 114, a respective purchased subset of the wellness programs is associated with a respective one of the employer records.

Referring again to FIG. 2, the employee health analysis system 14 in FIG. 1 associates a respective employee record with a respective employer record. For example, the employee records 1 to 3 are associated with the employer record 1 and the employee records 4 to 6 are associated with the employer record 2.

The employee health analysis system 14 also associates a plurality of medical variables with each employee record. For example, medical variables 1 and 2 are associated with employee record 1. A medical variable may for example be BMI, percent body fat, systolic blood pressure, diastolic blood pressure, total cholesterol, HDL cholesterol, LDL cholesterol, triglycerides, cholesterol ratio, tobacco use, diabetes, asthma, hypertension or hyperlipidemia.

Two employee records may have the same of different medical variables associated therewith. For example, the employee record 4 has medical variable 2 in common with employee record 1 and medical variable 3 that is not associated with employee record 1.

The medical variables associated with the employee records may for example be entered by first displaying an interface (not shown) for entering medical variables and then receiving an input of the medical variables. For each employee record, a plurality of medical variables is then stored so that the medical variables are associated with the employee record and through the employee record to the employer record. Alternatively, or in addition, medical variables can be imported in association with respective employee records, the employee records being associated with respective employer records.

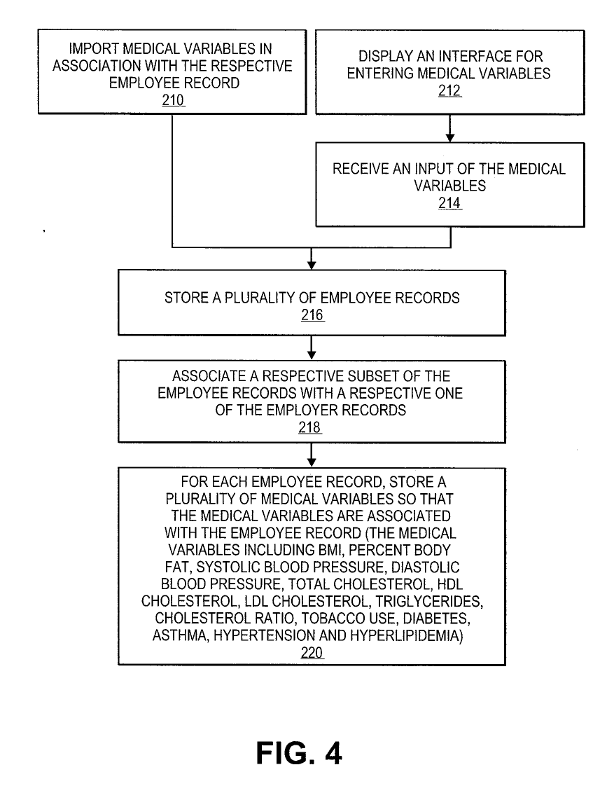

FIG. 4 shows an employee health analysis method that is carried out by the employee health analysis system 14 in FIG. 1. At block 210, medical variables are imported in association with respective employee records. At block 212, an interface is displayed for entering medical variables. At block 214, an input is received of the medical variables. Following blocks 210 and 214, at block 216, a plurality of employee records are stored. At block 218, a respective subset of employee records is associated with a respective one of the employer records. At block 220, for each employee record, a plurality of medical variables are stored so that the medical variables are associated with the employee records.

Referring again to FIG. 2, the employee health directive system 16 in FIG. 1 associates a selected one or more of the medical wellness programs with the employee records based on the medical variables. For example, the medical variable 1 may be for BMI and the medical wellness program 2 may be a nutrition program for weight loss. The medical wellness program 2 will be associated with the employer record 1 if the medical variable 1 is above or below a certain threshold. For example, in the case of BMI, a nutrition program will be associated to the employee record 1 if the medical variable for BMI is above 23.

What should be noted is that the medical wellness programs that are associated with the employee records are only selected from the purchased subset of the employer record associated with the employee record. For example, only medical wellness programs 1 to 3 can be associated with the employee record 1 because the employer record 1 associated with the employee record 1 is associated with a purchased subset of wellness programs including only medical wellness programs 1 to 3. Typically, not all the medical wellness programs 1 to 3 are associated with the employee record 1, but only one or a selected subset of the purchased subset of medical wellness programs. Similarly, only medical wellness programs 3 and 4 can be associated with employee record 4 due to medical variables 2 or 3 that are associated with employee record 4.

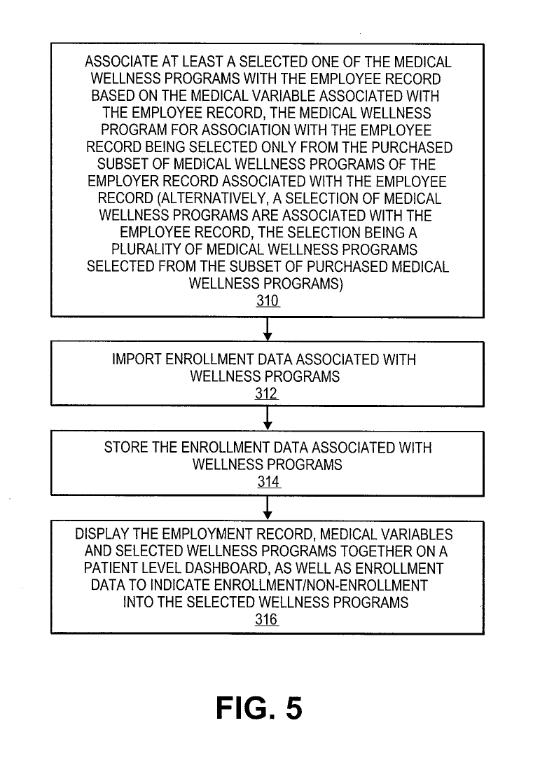

FIG. 5 illustrates an employee health directive method that is carried out by the employee health directive system 16 in FIG. 1, an enrollment method carried out by the enrollment system 18 and a data communication method carried out by the data communication system 20. At block 310 a selected one of the medical wellness programs is associated with an employee record based on the medical variable associated with the employee record. The medical wellness program for association with the employee record is selected only from the purchased subset of medical wellness programs of the employer record associated with the employee record. Alternatively, a selection of medical wellness programs are associated with the employee record, the selection being a plurality of medical wellness programs selected from the subset of purchased medical wellness programs. At block 310, enrollment data associated with wellness programs is imported. At block 314, the enrollment data is stored is association with the wellness programs. At block 316, the employee record, medical variables and selected wellness programs are displayed together on a patient level dashboard, as well as enrollment data to indicate enrollment/non-enrollment into the selected wellness programs.

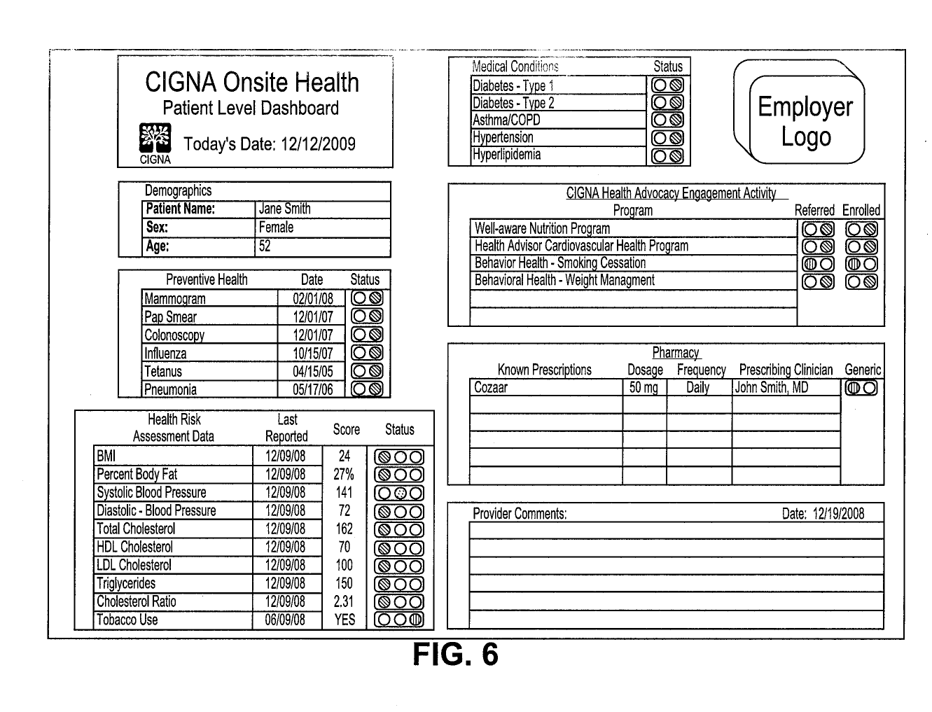

FIG. 6 illustrates a patient level dashboard 400 that displays the data as described in block 316 of FIG. 5. The patient level dashboard 400 includes identification data for the employee record (Jane Smith; Female; 52). The employee record may for example be employee record 1 in FIG. 2. The medical variables 1 and 2 in FIG. 2 are represented as BMI, percent body fat, systolic blood pressure, diastolic blood pressure, total cholesterol, HDL cholesterol, LDL cholesterol, triglycerides, cholesterol ratio, tobacco use, diabetes, asthma, hypertension or hyperlipidemia. Each medical variable is a numeric variable with a respective identifier such as “BMI” adjacent to the numerical variable.

Four medical wellness programs are displayed under the heading “Program”. The medical wellness programs are selected only from the purchased subset of medical wellness programs associated with the employer record 1 in FIG. 2. The purchased subset of medical wellness programs includes more than four, typically five or ten, medical wellness programs. However, only the four medical wellness programs that are selected based on the medical variables are displayed. For example, because the BMI is above 23, the medical wellness program entitled “Well-aware Nutrition Program” is displayed. The enrollment data is also displayed adjacent the medical wellness programs that are displayed. Specifically, an indicator shows whether the employee has been referred to a respective medical wellness program and whether the employee has enrolled into the respective medical wellness program.

The patient level dashboard 400 thus provides a management output for a relationship between an insurance provider that sells medical wellness programs and an employer that purchases such medical wellness programs. Following sale of the medical wellness programs by the insurance provider to the employer, the insurance provider can run a clinic on-site at an employer's location and/or import medical variables for determining which medical wellness programs apply to which employees. The employer that purchased the medical wellness programs from the insurance provider can thus be assured that employees of the employer are referred to and enrolled into the medical wellness programs that apply to them.

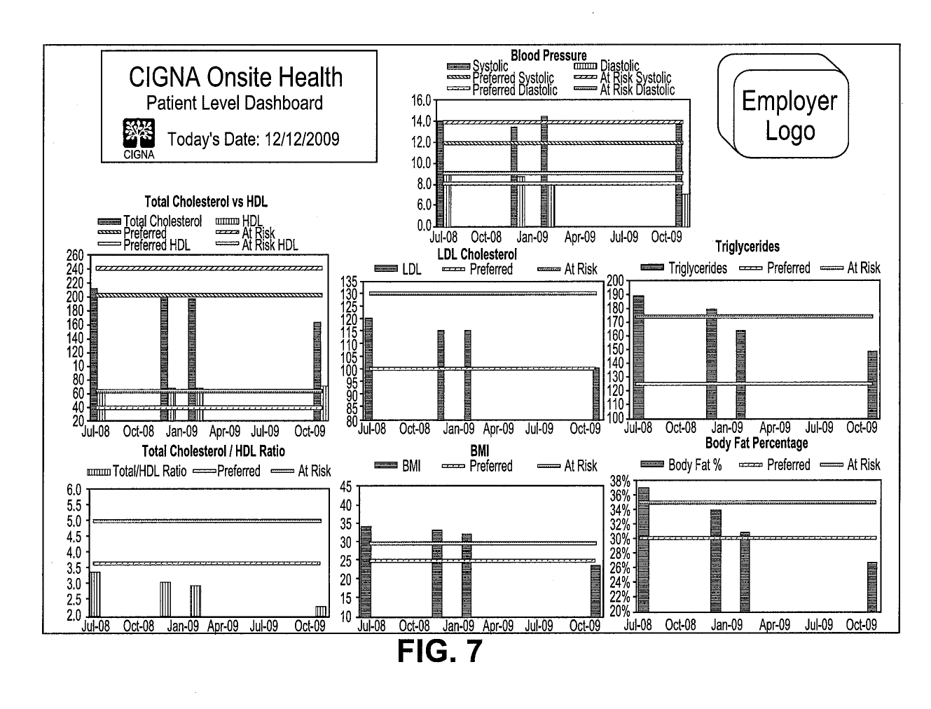

FIG. 6 shows a snapshot at a particular moment in time for one employee record. FIG. 7 shows a change over time for each one of the medical variables associated with the employee record. FIG. 7 thus assists the employee to visually ascertain a change in the medical variables over time. Each one of the medical variables also has “At Risk” thresholds so that the employee can ascertain a risk level for each medical variable.

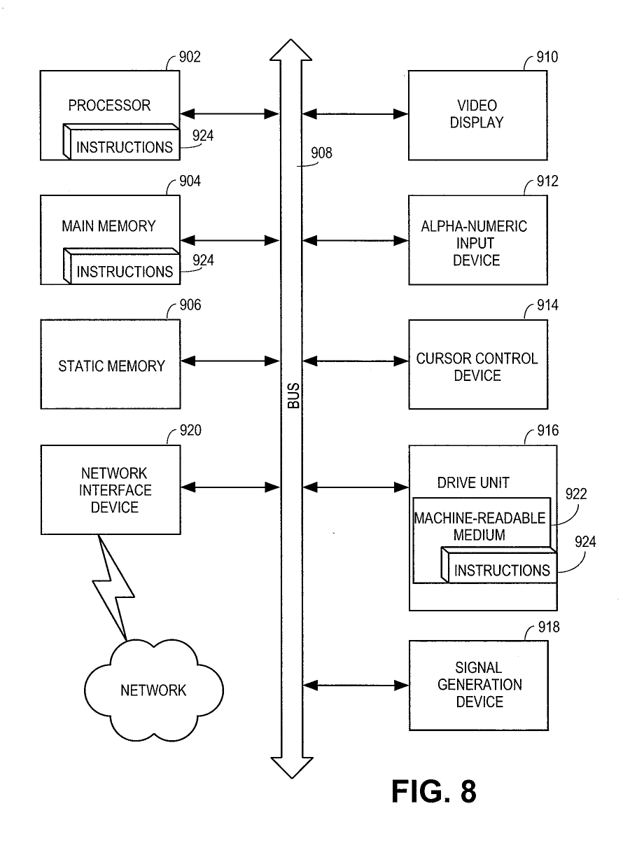

FIG. 8 shows a machine 900 in the exemplary form of the server or a personal computer as hereinbefore described within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processor 902 (e.g., a central processing unit (CPU), a graphics processing unit (GPU) or both), a main memory 904 (e.g., read only memory (ROM), flash memory, dynamic random access memory (DRAM) such as synchronous DRAM (SDRAM) or Rambus DRAM (RDRAM), etc.), and a static memory 906 (e.g., flash memory, static random access memory (SRAM), etc.), which communicate with each other via a bus 908.

The computer system 900 may further include a video display 910 (e.g., a liquid crystal display (LCD) or a cathode ray tube (CRT)). The computer system 900 also includes an alpha-numeric input device 912 (e.g., a keyboard), a cursor control device 914 (e.g., a mouse), a disk drive unit 916, a signal generation device 918 (e.g., a speaker), and a network interface device 920.

The disk drive unit 916 includes a machine-readable medium 922 on which is stored one or more sets of instructions 924 (e.g., software) embodying any one or more of the methodologies or functions described herein. The software may also reside, completely or at least partially, within the main memory 904 and/or within the processor 902 during execution thereof by the computer system 900, the main memory 904 and the processor 902 also constituting machine-readable media.

The software may further be transmitted or received over a network 928 via the network interface device 920.

While the machine-readable medium 924 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories, and optical and magnetic media.

It should be understood that “computer system” as used herein can comprise a single computer or multiple computers that are connected to one another over a network.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. An employee medical care management method comprising:
(i) a wellness program management method including:
storing a purchased subset of the wellness programs;
(ii) an employee health analysis method including:
storing a plurality of employee records; and
for each employee record, storing at least one medical variable so that the medical variable is associated with the employee record;
(iii) an employee health directive method including:
associating at least a selected one of the medical wellness programs with the employee record based on the medical variable associated with the employee record; and
providing an output with the selected medical wellness program being associated with the employee record.

2. The method of claim 1, wherein the wellness program management method includes:
storing a plurality of employee records; and
storing a plurality of wellness programs, wherein a respective purchased subset of the wellness programs is associated with a respective one of the employer records.

3. The method of claim 2, wherein, in the employee health directive method, the medical wellness program for association with the employee record is selected only from the purchased subset of medical wellness programs of the employer record associated with the employee record.

4. The method of claim 3, wherein, in the employee health directive method, a selection of medical wellness programs are associated with the employee record, the selection being a plurality of medical wellness programs selected from the subset of purchased medical wellness programs.

5. The method of claim 1, wherein the employee health analysis method includes:
importing the medical variable in association with the respective employee record.

6. The method of claim 1, wherein the employee health analysis method includes:
displaying an interface for entering the medical variable; and
receiving an input of the medical variable.

7. The method of claim 1, wherein the medical variable is at least one of BMI, percent body fat, systolic blood pressure, diastolic blood pressure, total cholesterol, HDL cholesterol, LDL cholesterol, triglycerides, cholesterol ratio, tobacco use, diabetes, asthma, hypertension and hyperlipidemia.

8. The method of claim 1, further comprising:
displaying the employee record, medical variable and selected wellness program together.

9. The method of claim 8, further comprising:
storing enrollment data associated with the wellness program; and
displaying the enrollment data to indicate enrollment/non-enrollment into the selected wellness program.

10. The method of claim 9, further comprising:
importing the enrollment data.

11. An employee medical care management method comprising:
(i) a wellness program management method including:
storing a plurality of employer records;
storing a plurality of wellness programs; and
associating a respective purchased subset of the wellness programs with a respective one of the employer records;
(ii) an employee health analysis method including:
storing a plurality of employee records; and
associating a respective subset of the employee records with a respective one of the employer records; and
for each employee record, storing at least one medical variable so that the medical variable is associated with the employee record; and
(iii) an employee health directive method including:
associating at least a selected one of the medical wellness programs with the employee record based on the medical variable associated with the employee record, the medical wellness program for association with the employee record being selected only from the purchased subset of medical wellness programs of the employer record associated with the employee record; and
providing an output with the selected medical wellness program being associated with the employee record.

12. An employee medical care management tool comprising:
(i) at least one processor;
(ii) at least one storage device connected to the processor;
(iii) a wellness program management system stored on the storage device and executable by the processor to carry out the method including:
storing a purchased subset of the wellness programs;
(iv) an employee health analysis system stored on the storage device and executable by the processor to carry out the method including:
storing a plurality of employee records; and
for each employee record, storing at least one medical variable so that the medical variable is associated with the employer record;
(v) an employee health directive system stored on the storage device and executable by the processor to carry out the method including:
associating at least a selected one of the medical wellness programs with the employee record based on the medical variable associated with the employee record; and
providing an output with the selected medical wellness program being associated with the employee record.

13. The employee medical care management tool of claim 12, wherein the wellness program management system carries out the method including:
storing a plurality of employer records; and
storing a plurality of wellness programs, wherein a respective purchased subset of the wellness programs is associated with a respective one of the employer records.

14. The employee medical care management tool of claim 13, wherein, in the employee health directive system, the medical wellness program for association with the employee record is selected only from the purchased subset of medical wellness programs of the employer record associated with the employee record.

15. The employee medical care management tool of claim 14, wherein, in the employee health directive system, a selection of medical wellness programs are associated with the employee record, the selection being a plurality of medical wellness programs selected from the subset of purchased medical wellness programs.

16. The employee medical care management tool of claim 12, wherein the employee health analysis system carries out the method including:
importing the medical variable in association with the respective employee record.

17. The employee medical care management tool of claim 12, wherein the employee health analysis system carries out the method including:
displaying an interface for entering the medical variable; and
receiving an input of the medical variable.

18. The employee medical care management tool of claim 12, wherein the medical variable is at least one of BMI, percent body fat, systolic blood pressure, diastolic blood pressure, total cholesterol, HDL cholesterol, LDL cholesterol, triglycerides, cholesterol ratio, tobacco use, diabetes, asthma, hypertension and hyperlipidemia.

19. The employee medical care management tool of claim 12, further comprising:
a data communication system carries out the method including:
displaying the employee record, medical variable and selected wellness program together.

20. The employee medical care management tool of claim 19, wherein the data communication system carries out the method including:
storing enrollment data associated with the wellness program; and
displaying the enrollment data to indicate enrollment/non-enrollment into the selected wellness program.

21. The employee medical care management tool of claim 20, wherein the data communication system carries out the method including:
importing the enrollment data.

22. An employee medical care management tool comprising:
(i) at least one processor;
(ii) at least one storage device connected to the processor;
(iii) a wellness program management system stored on the storage device and executable by the processor to carry out the method including:
storing a plurality of employer records;
storing a plurality of wellness programs; and
associating a respective purchased subset of the wellness programs with a respective one of the employer records;
(iv) an employee health analysis system stored on the storage device and executable by the processor to carry out the method including:
storing a plurality of employee records; and
associating a respective subset of the employee records with a respective one of the employer records; and
for each employee record, storing at least one medical variable so that the medical variable is associated with the employee record; and
(v) an employee health directive system stored on the storage device and executable by the processor to carry out the method including:
associating at least a selected one of the medical wellness programs with the employee record based on the medical variable associated with the employee record, the medical wellness program for association with the employee record being selected only from the purchased subset of medical wellness programs of the employer record associated with the employee record; and
providing an output with the selected medical wellness program being associated with the employee record.
